(19) United States
(12) Patent Application Publication
(10) Pub. No.: US 2016/0368129 A1
(43) Pub. Date: Dec. 22, 2016

(54) GRIPPING AID

(71) Applicant: George Robert Lampman, North Hollywood, CA (US)

(72) Inventor: George Robert Lampman, North Hollywood, CA (US)

(21) Appl. No.: 14/741,721

(22) Filed: Jun. 17, 2015

(51) Int. Cl. B25G 1/10

(52) U.S. Cl. CPC B25G 1/102

(57) ABSTRACT

A gripping aid for an airbrush that has an elongated body with a longitudinal axis, a handle portion at a first end and a spray delivery nozzle at a second end of the elongated body, a gas supply connection and a fluid reservoir, both extending transversely to the longitudinal axis and away from the elongated body, the gripping aid including a one-piece body of soft, flexible, resilient material. The one-piece body having a main body portion configured to fit around only a portion of the circumference of the airbrush elongated body, and an annular portion configured to fit around the entirety of the circumference of the airbrush elongated body.

### BACKGROUND OF THE INVENTION

Field of the Invention

This invention relates to gripping aids, referred to variously as wraps or grips, particularly for handheld airbrushes.

Description of the Related Art

Airbrushes have been employed for many years in the application of atomized media, such as cosmetics, or makeup, or even paint. A typical airbrush operates by passing a stream of compressed gas, typically air, through a venturi that generates a localized zone of reduced pressure or suction. This suction is used to draw a fluid, typically liquid, from a connected reservoir. The velocity of the compressed gas stream atomizes the liquid into very tiny droplets as the liquid is driven past a metering device where it is directed to a surface thereafter. The amount of delivered liquid is typically controlled via a lever that may also control the liquid flow. Liquid flow may also be metered by a needle valve. In a “single action” airbrush, the liquid flow alone is controlled by the trigger while the compressed gas flow may be controlled by a external knob or dial. Such an airbrush, also known in the field as a stylus, is described in U.S. Patent Pub. 2103/0219666, the disclosure of which is incorporated herein by reference.

While such appliances can produce an attractive result, they have been used primarily by professional mainly because airbrushes by themselves are difficult to handle. One reason for this is the low coefficient of friction of the metal of which the airbrushes are typically made, giving the appliance a slippery surface.

While gripping aids have been previously proposed, they are not completely satisfactory.

### BRIEF SUMMARY OF THE INVENTION

The present invention provides improved gripping aids of a relatively soft, elastic material, having a comparatively high coefficient of friction and configured to be held more securely on the airbrush body.

In particular, gripping aids according to the invention include an closed annular portion that extends completely around the airbrush body, thereby greatly enhancing the security of the attachment of the gripping aid to the airbrush body. The result is an airbrush that can be held and manipulated more easily and comfortably, thus enabling untrained nonprofessionals to use the airbrush effectively with minimal practice.

It has been found that a gripping aid according to the invention gives the airbrush a surprisingly easy and natural ergonomic tactile feel when held. The gripping aid enables an untrained user to intuitively hold the airbrush with a very light touch. It is then easier to intuitively touch the lever lightly, which is essential to achieve the desired results. It also facilitates mastery of more advanced artistic goals and techniques.

### BRIEF DESCRIPTION OF THE DRAWINGS

FIG. 1 is a perspective view showing two gripping aids according to the invention mounted on an air brush.

FIG. 2 is a top plan view of a preferred embodiment of a first gripping aid according to the invention.

FIG. 3 is a side elevational view of the embodiment of FIG. 2.

FIG. 4 is a rear elevational view of the embodiment of FIG. 2.

FIGS. 5, 6 and 7 are perspective views of the embodiment of FIG. 2, FIGS. 5 and 6 being views from above and FIG. 7 being a view from below.

FIG. 8 is an exploded view of the airbrush and gripping aids.

### DETAILED DESCRIPTION OF THE INVENTION

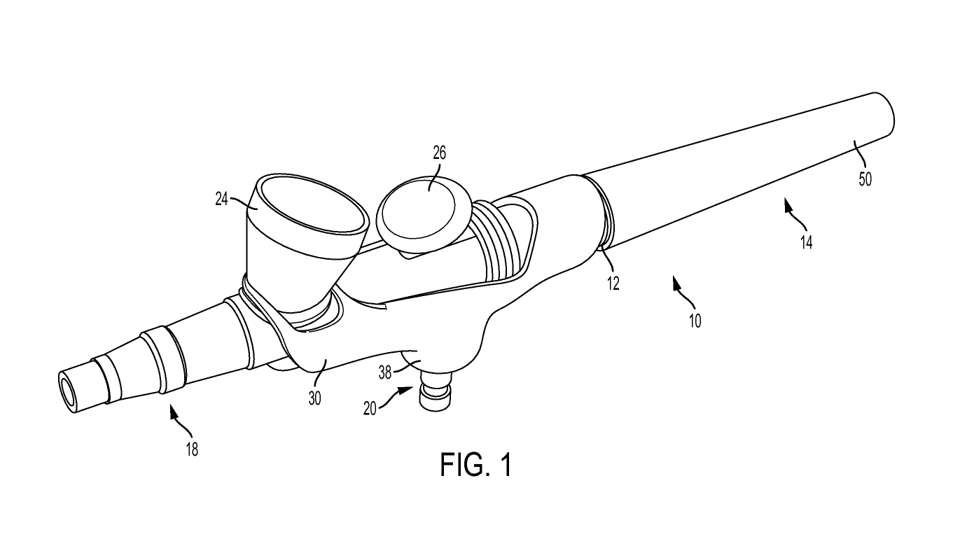

Referring first to FIG. 1, the gripping aids according to the present invention are configured for attachment to an airbrush 10 particularly adapted for the application of beauty products. Airbrush 10 comprises a tubular main body 12 having a longitudinal axis, a tubular handle 14, a spray nozzle 18, a pressurized air supply port 20 for connection to a pressurized air supply, a reservoir 24 for receiving fluid to be sprayed, and a switch, or trigger, or toggle button, 26 that is manually operable to control the flow of pressurized air from port 20 to nozzle 18.

Air supply port 20 extends transversely, or substantially perpendicular, to the longitudinal axis of main body 12, away from main body 12, and reservoir 24 and trigger 26 also extend transversely to the longitudinal axis of main body 12, away from main body 12. When the airbrush is in use, port 20 extends downwardly and reservoir 24 and trigger 26 extend upwardly. Thus, port 20 is at the opposite side of main body 12 from reservoir 24 and trigger 26.

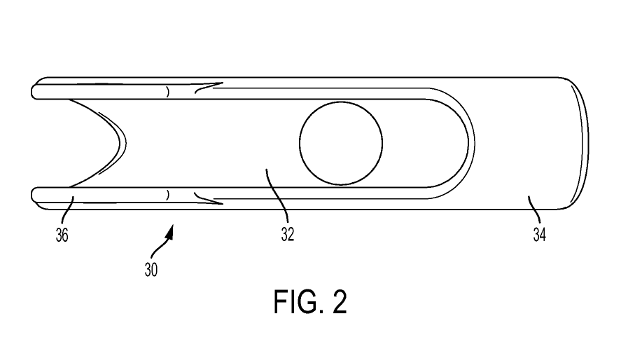

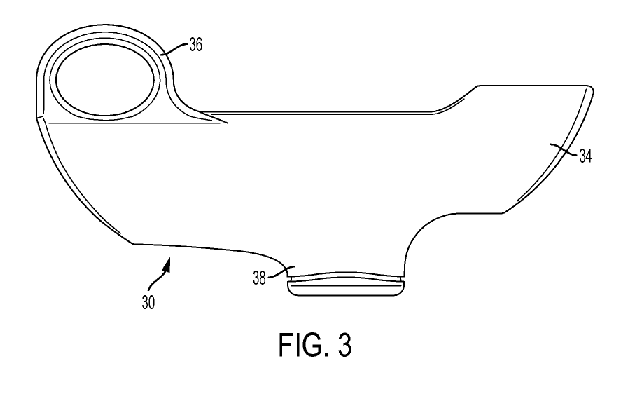

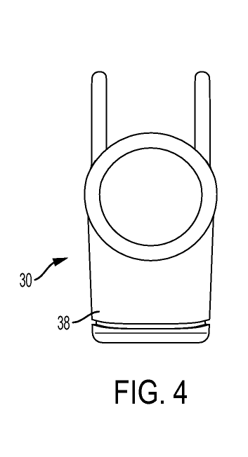

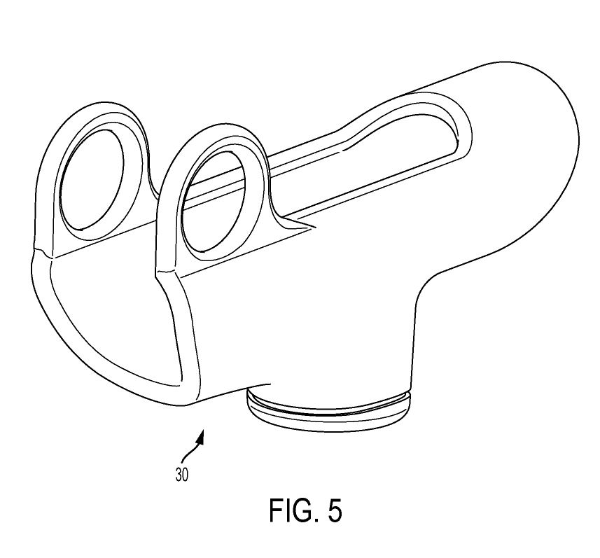

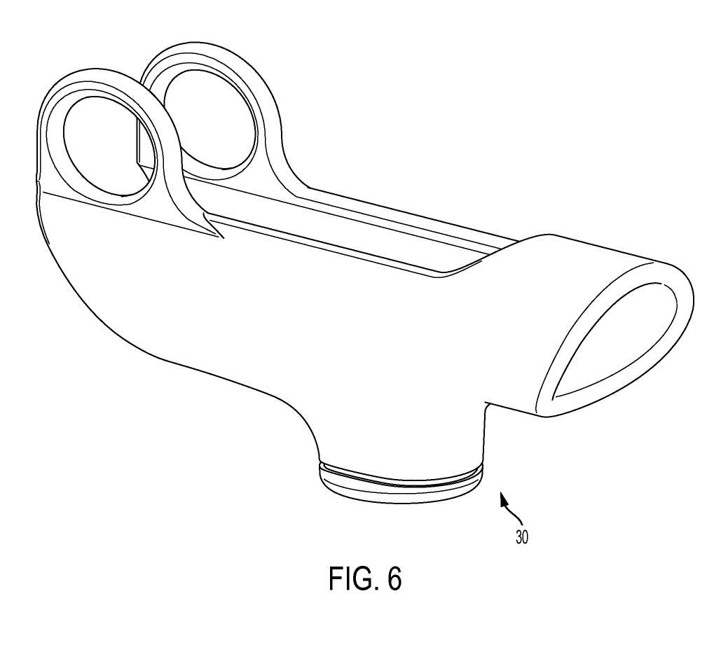

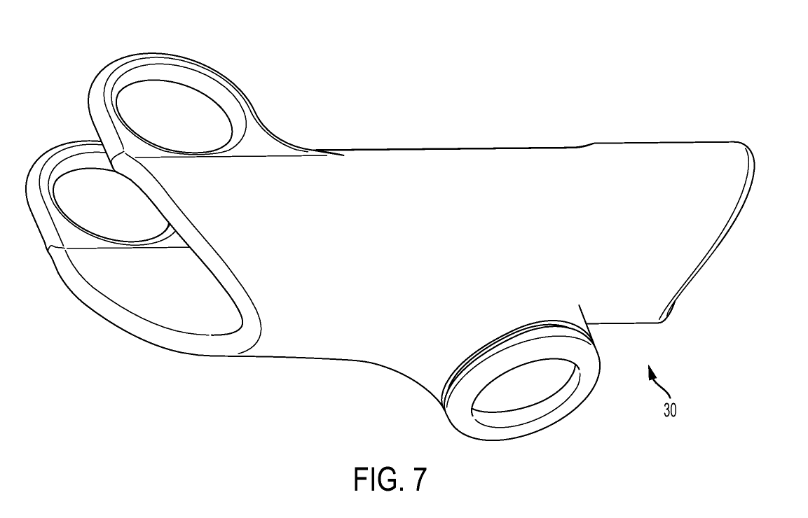

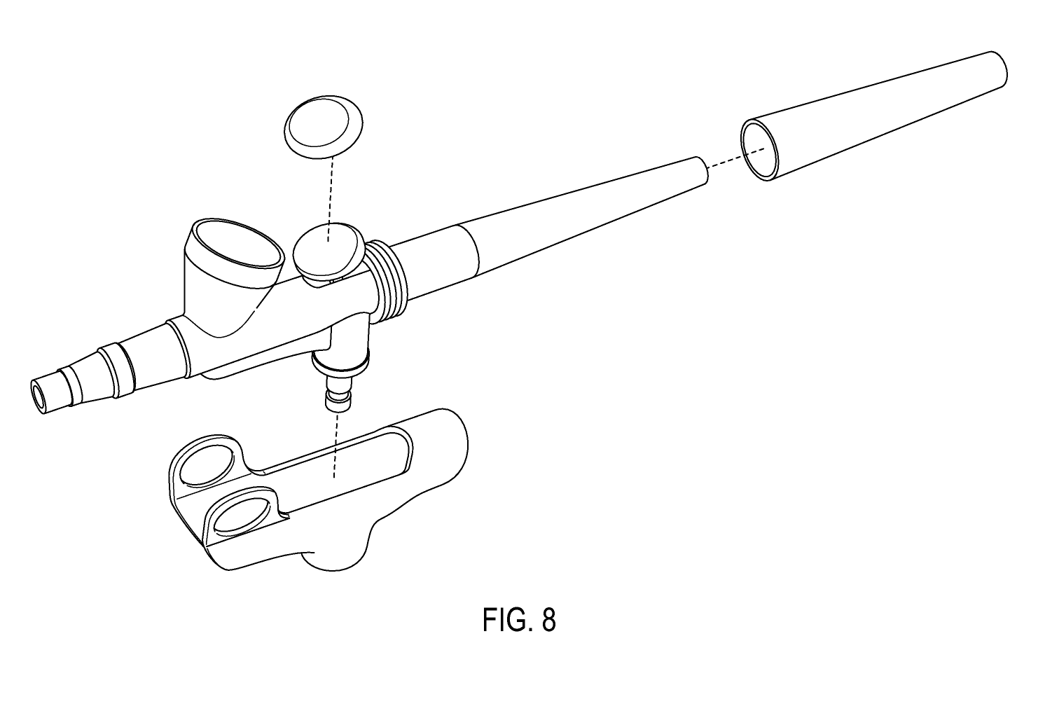

FIG. 1 shows a first gripping aid 30 and a second gripping aid 50. Each gripping aid may be made of a suitable soft, pliant, resilient material such as silicone rubber. Gripping aid 30 is shown in greater detail in FIGS. 2-7. Gripping aid 50 is shown only in FIG. 1 and will be described in detail below.

Referring to FIGS. 2-7 as a group, it can be seen that gripping aid 30 is a one-piece body, although it may be made fabricated by bonding together components of different materials.

Gripping aid 30 is composed of a main body portion 32 having a generally U-shaped cross section such that portion 32 fits around only a part of the circumference of main body 12 of airbrush 10.

At one end of gripping aid 30, there is provided an annular body portion 34 that will extend continuously around main body 12 of airbrush 10, as can be seen in FIG. 1, and is preferably dimensioned to fit snugly around main body 12. Annular body portion is instrumental in providing a secure, immovable coupling between the gripping aid and the airbrush.

Gripping aid 30 further includes at least one, and preferable two, annular rings, or loops 36, located to be adjacent to and to be fitted around, reservoir 24 when gripping aid 30 is coupled to airbrush 10. For this purpose, the material of loops 36 has sufficient elastic stretchability to be stretched over the top of reservoir 24 and then slid down to the base of the reservoir, as shown.

Gripping aid 30 also has a protuberant portion 38 with an opening to fit around air supply port 20.

Each gripping aid 30 and 50 can be manufactured by molding to have, in its relaxed state, a configuration conforming, or at least approximately conforming, to the configuration that it will have when coupled, or fitted, to the airbrush, with the exception of loops 36, which will be placed around reservoir 24, as described above.

Although exemplary embodiments of the present invention have been described, this should not be construed to limit the scope of the appended claims. Those skilled in the art will understand that various modifications may be made to the described embodiment. Moreover, to those skilled in the various arts, the invention itself a described herein will suggest solutions to other tasks and adaptations for other applications. It is therefore desired that the present embodiments be considered in all respects as illustrative and not restrictive, reference being made to appended claims rather than the foregoing description to indicate the scope of the invention.

What is claimed is:

1. A gripping aid for an airbrush that has an elongated body with a longitudinal axis, a handle portion at a first end and a spray delivery nozzle at a second end of the elongated body, a gas supply connection and a fluid reservoir, both extending transversely to the longitudinal axis and away from the elongated body, said gripping aid comprising:
a one-piece body of soft, flexible, resilient material said one-piece body comprising:
a main body portion configured to fit around only a portion of the circumference of the airbrush elongated body; and
an annular portion configured to fit around the entirety of the circumference of the airbrush elongated body.

2. The gripping aid of claim 1, further comprising at least one annular loop extending from the main body portion of said gripping aid and configured to be fitted around the fluid reservoir of the airbrush.

3. A kit comprising the gripping aid of claim 2 in combination with a second gripping aid constituted by a second one-piece body of soft, flexible, resilient material having a generally conical or frustoconical form and configured to fit securely around the handle portion of the airbrush.

4. A kit comprising the gripping aid of claim 1 in combination with a second gripping aid constituted by a second one-piece body of soft, flexible, resilient material having a generally conical or frustoconical form and configured to fit securely around the handle portion of the airbrush.

5. A combination comprising:
An airbrush comprising: an elongated body with a longitudinal axis, a handle portion at a first end and a spray delivery nozzle at a second end of the elongated body; a gas supply connection and a fluid reservoir, both extending transversely to the longitudinal axis and away from the elongated body,
and a gripping aid securely fitted to said airbrush, said gripping aid comprising:
a one-piece body of soft, flexible, resilient material said one-piece body comprising:
a main body portion fitted securely around only a portion of the circumference of said airbrush elongated body; and
an annular portion fitted securely around the entirety of the circumference of said airbrush elongated body.

6. The combination of claim 1, wherein said gripping aid further comprises at least one annular loop extending from the main body portion of said gripping aid and fitted around said fluid reservoir of said airbrush.
